(19) United States
(12) Patent Application Publication
(10) Pub. No.: US 2014/0041237 A1
(43) Pub. Date: Feb. 13, 2014

(54) New-Style Peeling Device

(71) Applicant: Fang Han, Wuhan City (CN)

(72) Inventor: Fang Han, Wuhan City (CN)

(21) Appl. No.: 14/006,650

(22) PCT Filed: Feb. 15, 2012
(86) PCT No.: PCT/CN12/71144

§ 371 Date: Oct. 18, 2013

(30) Foreign Application Priority Data
Feb. 22, 2011 (CN) 201110042763.9

(51) Int. Cl. A47J 17/02

(52) U.S. Cl. CPC A47J 17/02
USPC 30/319

(57) ABSTRACT

A new-style peeling device, comprising a blade (1), and a blade bracket (2) provided with a handle (3) at the lower part of the peeling device, and the blade bracket is provided with a rotating shaft (4) configured at the top of the blade bracket (2) to support the blade. Both ends of the blade (1) are respectively provided with a shaft sleeve (5) that accommodates the rotating shaft (4); the blade (1) is movably connected with the rotating shaft of the blade bracket (2) through the shaft sleeve (5). The present invention permits the peeling of objects with a large plane, and is suitable for peeling vegetables and fruits, etc.

### TECHNICAL FIELD

The present invention relates to a cutting tool, specifically to a new-style peeling device.

### BACKGROUND ARTS

Before this invention is put forward, peeling devices have become common peeling tools due to its advantages of safety, convenience, and high efficiency. The structure a peeler generally comprises: a blade provided with a rotating shaft; a blade bracket provided a mounting hole adapted for supporting the blade, the top of the blade bracket is higher than that of the blade. In a peeling device disclosed in patent 200520058987.9, the blade is located in the bracket, thus it is hard to guarantee that the whole blade is completely in contact with the objects to be peeled when peeling. Therefore, when using the peeler to peel an object with a large plane, the large plane(s) of the object would be impeded by the top of the blade bracket, result in inaccessibility to peel due to that the blade cannot reach the large plane(s) of the object.

### CONTENTS OF THE INVENTION

The goal of the present invention is to overcome the shortages in the background arts, and to provide a new-style peeling device with simple structure, low cost and enable to peel for the objects of big plane surface.

In order to achieve the goal, the present invention provides a new-style peeling device comprising a blade, and a blade bracket provided with a handle at the low part of the blade bracket, and at the top of the blade bracket is provided with a rotating shaft configured to support the blade, both ends of the blade are respectively provided with a shaft sleeve that accommodates the rotating shaft, and the blade is movably connected with the rotating shaft of the blade bracket through the shaft sleeve.

According to the above technical solution, the rotating shaft arrangement can be divided into two cases:

In the first case, the rotating shaft is arranged at the inner sides of blade bracket;

In the second case, the rotating shaft is arranged at the outer sides of blade bracket.

As compared with the prior arts, the superiority of the invention lies in that the claimed peeling device features simple structure, low cost, ease to use, and high efficiency, and is also capable of peeling objects with large planes.

It is preferably that a chip is embedded in any of the components in the peeler according to the invention. In this manner, archival information may be marked on the peeling device by manufacturer, thereby preventing counterfeiting and forging, and being conducive to building a famous brand.

### BRIEF DESCRIPTION OF THE DRAWINGS

FIG. 1 schematically illustrates the structure of the existing peeler;

FIG. 2 schematically illustrates the structure of the blade of the existing peeler;

FIG. 3 schematically illustrates the structure of peeling device according to Embodiment 1 of the invention;

FIG. 4 schematically illustrates the structure of peeling device according to Embodiment 2 of the invention;

FIG. 5 illustrates the front view of the structure of the blade of peeling device according to the present invention;

FIG. 6 illustrates the side view of the structure of the blade of the peeling device according to the invention.

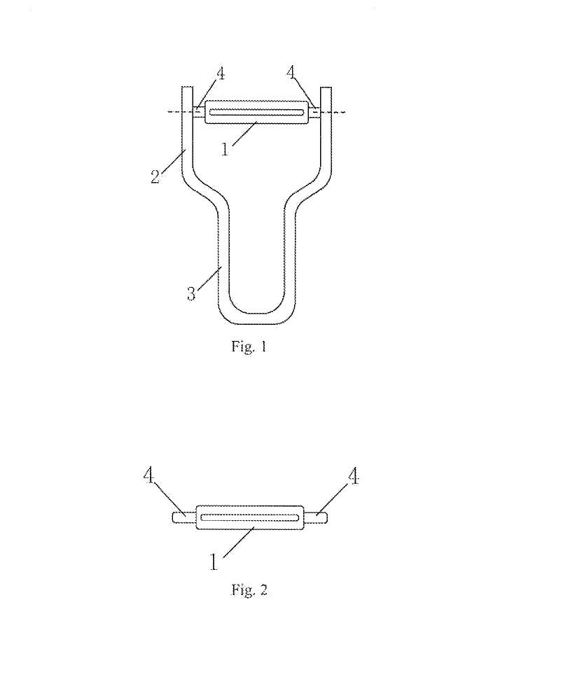

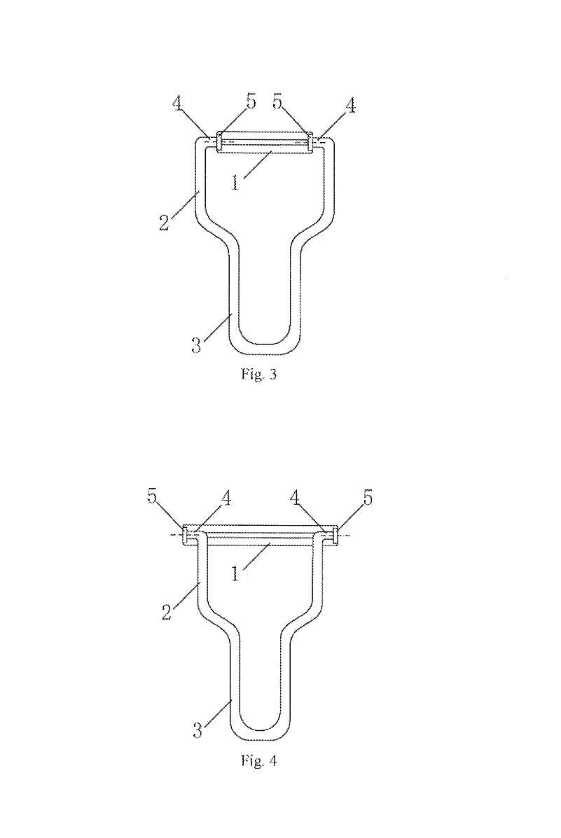

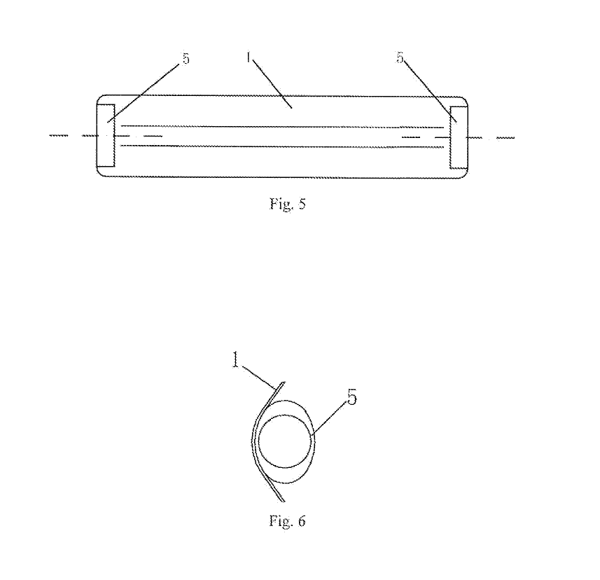

In the figures: 1 refers to the blade, 2 to the blade bracket, 3 to the handle, 4 to the rotating shaft, and 5 to the shaft sleeve.

### SPECIFIC MODE FOR CARRYING OUT THE INVENTION

Further details will be provided in combination of figures and embodiments, but they shouldn't be understood as limitation to the invention.

Embodiment 1 provides a new-style peeling device comprising a blade 1, a blade bracket 2 provided with a handle 3 at the lower part of the peeling device, at the top the blade brackets 2 is provided with a rotating shaft 4 configured to support the blade 2; both ends of the blade 1 are respectively provided with a shaft sleeve 5 that accommodates the rotating shaft 4; the blade is movably connected with the rotating shaft of the blade bracket 2 through the shaft sleeve 5. The blade 1 is arranged under the top of blade bracket 2; and the rotating shaft 4 is arranged at the inner sides of the blade bracket 2.

Embodiment 2 provides a new-style peeling device comprising a blade 1, a blade bracket 2 provided with a handle 3 at the lower part of the peeling device, at the top of the blade brackets 2 is provided with a rotating shaft 4 configured to support the blade 2; both ends of the blade 1 are respectively provided with a shaft sleeve 5 that accommodates the rotating shaft 4; the blade is movably connected with the rotating shaft of the blade bracket 2 through the shaft sleeve 5. The blade 1 is arranged under the top of blade bracket 2; and the rotating shaft 4 is arranged at outer sides of the blade bracket 2.

1. A new-style peeling device, comprising a blade, and a blade bracket provided with a handle at the lower part of the bracket, characterized in that at the top of blade bracket is provided with a rotating shaft configured to support the blade, both ends of blade is provided with a shaft sleeve that accommodates the rotating shaft, and the blade is movably connected with the rotating shaft of the blade bracket through the shaft sleeve.

2. A new-style peeling device as described in claim 1, characterized in that the rotating shaft is arranged at inner sides of the blade bracket.

3. A new-style peeling device as described in claim 1, characterized in that the rotating shaft is arranged at outer sides of the blade bracket.

4. A new-style peeling device as described in claim 1, characterized in that the blade is arranged under the top of blade bracket.

5. A new-style peeling device as described in claim 2, characterized in that the blade is arranged under the top of blade bracket.

6. A new-style peeling device as described in claim 3, characterized in that the blade is arranged under the top of blade bracket.
